(19) United States
(12) Patent Application Publication
(10) Pub. No.: US 2013/0147757 A1
(43) Pub. Date: Jun. 13, 2013

(54) DISPLAY DEVICE AND INPUT DEVICE WITH MULTI LUMINOUS PATTERN LAYERS

(71) Applicant: Chung-Yuan Chen, Taipei (TW)

(72) Inventor: Chung-Yuan Chen, Taipei (TW)

(73) Assignee: PRIMAX ELECTRONICS LTD., Taipei (TW)

(21) Appl. No.: 13/401,507

(22) Filed: Feb. 21, 2012

(30) Foreign Application Priority Data
Dec. 9, 2011 (TW) 100145598

(51) Int. Cl. G06F 3/045; G06F 3/041; G09F 13/18

(52) U.S. Cl. 345/174; 362/602; 345/173

(57) ABSTRACT

The present invention discloses an input device with multi luminous pattern layers including an input interface, at least one first light emitting element, a first light guiding plate, at least one second light emitting element, a second light guiding plate and a circuit board. The input interface is stacked on the first light guiding plate, and first light guiding plate is stacked on the second light guiding plate. The first light emitting element and the second light emitting element are arranged beside the first light guiding plate and the second light guiding plate, such that the width of the input device with multi luminous pattern layers can be reduced by disposing the first light emitting element and the second light emitting element on one circuit board without another circuit board.

### FIELD OF THE INVENTION

The present invention generally relates to a display device and an input device, and more particularly to a display device capable of displaying different patterns and an input device with two input mode.

### BACKGROUND OF THE INVENTION

In general, the display device includes at least a light emitting element and at least a light guiding plate, while there are a plurality of luminous patterns disposed on the light guiding plate. When the light emitting element generates a light beam and the light beam is projected into the light guiding plate to pass through the plurality of luminous patters, the plurality of luminous patters are displayed on the light guiding plate. Furthermore, once the display device is assembled with a touch input interface, a touch input device is formed.

Applications of the touch input device is quite extensive. Currently, some of the touch input device which is commercially available has two kinds of different input modes simultaneously. Herein, the touch input device has a luminous module, and a first input mode is provided when the luminous module is turned on and thus the touch input device shows a predetermined pattern, while a second input mode is provided when the luminous module is turned off and thus the predetermined pattern is not shown. In another word, a user may recognize which input mode it is switched to currently by whether the pattern is shown or not, and then input signals according to the current input mode. For example, when the luminous module is turned off, an appearance of the touch input device is presented as a whole black state and the input mode is preset as a mode for controlling a mouse cursor. At this time, the user can implement motions of moving the mouse cursor and clicking according to the appearance of the touch input device is presented as the whole black state. On the contrary, when the luminous is turned on, a luminous keyboard is presented on the touch input device and the input mode is preset as another mode for controlling a keyboard. At this time, the user can input letters and symbols by the touch input device according to the presented luminous keyboard pattern. Therefore, one of the design points of such a luminous touch input device is how to ensure that the pattern is not shown when the luminous module is turned off, but the luminous pattern is shown only when the luminous module is turned on, so as to avoid confusing the user.

FIG. 1 illustrates a structural schematic side view of a conventional luminous input device. Referring to FIG. 1, the conventional luminous input device 1 comprises an input interface 11, a luminous module 12 and a Mylar plate 13, wherein a bottom-up arranging sequence thereof is the input interface 11, the luminous module 12 and the Mylar plate 13. The input interface 11 is capable of generating a corresponding signal by being activated by the user with a finger or a stylus. Furthermore, the luminous module 12 comprises a plurality of light emitting elements 121 and a light guiding plate 122, wherein the plurality of light emitting elements 121 are capable of generating at least a light beam (not shown), and the light guiding plate 122 is arranged among the light emitting elements 121 and capable of guiding the light beam, so as to project the light beam to the input interface 11. Herein, each one of the light emitting elements 121 is a light emitting diode (LED). In addition, the Mylar plate 13 has a plurality of luminous patterns 131, and the plurality of luminous patterns 131 are disposed on a lower surface 133 of the Mylar plate 13. Herein, the plurality of luminous patterns 131 are formed by printing a light transmissive black printing ink with a light shading rate about 98%, and the regions outside the plurality of luminous patterns 131 are formed by printing an opaque black printing ink, so as to form a plurality of light shading layers 132. Hence, the light can pass through the lower surface 133 of the Mylar plate 13 from where is printed with the plurality of luminous patterns 131 only, but is unable to pass through from the other regions of the lower surface 133 outside the plurality of luminous patterns 131. When the luminous module 12 of the luminous input device 1 is turned off, there is still faint light entering into the luminous input device 1 from the environment. However, the light quantity of the 2% faint light coming from the environment and passing through the regions printed with the plurality of luminous patterns 131 is too weak to be distinguished from the light quantity of the light coming from the environment by the user via his eyes due to the light shading rate of the luminous patterns 131 in the region is about 98%. As a result, the plurality of luminous patterns 131 on the Mylar plate 13 are unable to be displayed, i.e. are unable to be seen by the user. In contrast, when the luminous module 12 of the luminous input device 1 is turned on, there is a significant amount of light beams entering into the luminous input device 1. In such an instance, a difference between the light quantities of the light passing through the regions printed with the plurality of luminous patterns 131 and the light coming from the environment is enough to be distinguished by human eyes although there is only 2% of the light coming from the environment passing through the Mylar plate 13. As a result, the user can recognize the inputting locations indicated by the plurality of luminous patterns 131 on the luminous input device 1 due to the plurality of luminous patterns 131 are observable. The above mentioned descriptions are the structure and the function of a kind of the conventional touch input devices.

However, with the development of technology, the functions of the touch input devices become more abundant, and a kind of the commercially available input devices with multi luminous pattern layers is already introduced. FIG. 2 illustrates a structural schematic side view of a conventional input device with multi luminous pattern layers. Referring to FIG. 2, the input device 2 with multi luminous pattern layers comprises an input interface 21, a plurality of first luminous modules 22, a plurality of second luminous modules 23, a plurality of circuit boards 24, a plurality of light shading plate 25 and a protective layer 26. Herein, a bottom-up arranging sequence thereof is the input interface 21, the second luminous modules 23, the light shading plate 25, the first luminous modules 22 and the protective layer 26. Each one of the first luminous modules 22 includes two first light emitting elements 221 and a first light guiding plate 222. Herein, each one of the first light emitting elements 221 is capable of generating a first light beam (not shown), while the first light guiding plate 222 is arranged between the two first light emitting elements 221 and capable of guiding the first light beams, such that the first light beams are projected to the input interface 21. In addition, the first light guiding plate 222 has a plurality of first luminous patterns 2221, which are disposed to a lower surface 2222 of the first light guiding plate 222. In another word, when the first light emitting elements 221 generate the first light beams, the first luminous patterns 2221 are displayed on the first light guiding plate 222, wherein the plurality of first luminous patterns 2221 form as an Alphanumeric keyboard interface capable of being used to input letters of the alphabet and numbers.

Furthermore, each one of the second luminous modules 23 includes two second light emitting elements 231 and a second light guiding plate 232. Herein, each one of the second light emitting elements 231 is capable of generating a second light beam (not shown), while the second light guiding plate 232 is arranged between the two second light emitting elements 231 and capable of guiding the second light beams, such that the second light beams are projected to the input interface 21. In addition, the second light guiding plate 232 has a plurality of second luminous patterns 2321, which are disposed to a lower surface 2322 of the second light guiding plate 222. In another word, when the second light emitting elements 231 generate the second light beams, the second luminous patterns 2321 are displayed on the second light guiding plate 232, wherein the plurality of second luminous patterns 2321 form as a Chinese keyboard interface capable of being used to input Chinese characters. Moreover, all of the first light emitting elements 221 and the second light emitting elements 231 are LEDs.

As illustrated in FIG. 2, the protective layer 26 is disposed over the first luminous modules 22, and the protective layer 26 is capable of protecting the first luminous modules 22 against the collision or the friction provided by an external force. The protective layer 26 has a light shading layer 261, and the light shading layer 261 is disposed to an upper surface 262 of the protective layer 26. In addition, the light shading layer 261 is capable of shading most of the first light beams, most of the second light beams or the external light, wherein the light shading layer 261 is formed by using a light shading printing ink to print on the upper surface 262 of the protective layer 26, and a predetermined light shading rate of the light shading layer 261 is about 98%. Moreover, each one of the circuit board 24 is disposed at a side of the first luminous modules 22 and the second luminous modules 23 and perpendicular to the light shading plate 25. Furthermore, the first light emitting elements 221 and the second light emitting elements 231 are disposed on the circuit boards 24, wherein the circuit boards 24 correspond to each other. Further, according to FIG. 2, it can be understood that all of the first light emitting elements 221 and the second light emitting elements 231 are top-view LEDs.

Besides, each one of the light shading plates 25 is disposed between one of the first light guiding plate 222 and the corresponding one of the second light guiding plate 232 and capable of shading the first light beams generated by the first light emitting elements 221. As a result, it is able to prevent the first light beams from being projected to the second light guide plate 232 and thus affecting the second luminous patterns 2321 of the second luminous modules 23 being displayed on the second light guiding plate 232. Similarly, the light shading plates 25 are capable of shading the second light beams generated by the second light emitting elements 231 as well. As a result, it is able to prevent the second light beams from being projected to the first light guide plate 222 and thus affecting the first luminous patterns 2221 of the first luminous modules 22 being displayed on the first light guiding plate 222.

When all of the first luminous modules 22 and the second luminous modules 23 of the input device 2 with multi luminous pattern layers are turned off, there is still faint light entering into the input device 2 with multi luminous pattern layers from the environment. However, the light quantity of the 2% faint light coming from the environment and passing through the light shading layer 261 is too weak to be distinguished from the light quantity of the light coming from the environment by the user via his eyes due to the predetermined light shading rate of the light shading layer 261 is about 98%. As a result, the plurality of first luminous patterns 2221 on the first light guiding plate 222 and the plurality of second luminous patterns 2321 on the second light guiding plate 232 are unable to be displayed, i.e. are unable to be seen by the user. In contrast, when the first luminous modules 22 of the input device 2 with multi luminous pattern layers is turned on, there is a significant amount of light beams entering into the input device 2 with multi luminous pattern layers. In such an instance, a difference between the light quantities of the light passing through the light shading layer 261 and the light coming from the environment is enough to be distinguished by human eyes although there is only 2% of the light coming from the environment passing through the light shading layer 261. As a result, the user can recognize the inputting locations indicated by the first luminous patterns 2221 on the input device 2 with multi luminous pattern layers due to the plurality of first luminous patterns 2221 are observable. In addition, the operation case for turning on the second luminous modules 23 of the input device 2 with multi luminous pattern layers is substantially the same as the operation case for turning on the first luminous modules 22 of the input device 2 with multi luminous pattern layers and thus is omitted herein.

In order to prevent a thickness from too thick, each one of the first light emitting elements 221 and the second light emitting elements 231 inside the conventional input device 2 with multi luminous pattern layers is practiced by using the LED with a smaller volume and a thickness thereof is about 0.4 mm. Since the first light emitting elements 221 and the second light emitting elements 231 are smaller in volume, the manufacturing costs thereof are higher. Similarly, since the first light emitting elements 221 and the second light emitting elements 231 are smaller in volume, the luminous efficiency of the first light beams and the second light beams respectively generated by the first light emitting elements 221 and the second light emitting elements 231 are reduced accordingly. Therefore, the first light beams and the second light beams are unable to respectively pass through the first light guiding plate 222 and the second light guiding plate 232 completely, and thus it is necessary to dispose the first luminous modules 22 and the second luminous modules 23 at two opposite ends of the first light guiding plate 222 and the second light guiding plate 232 respectively. As a result, not only the manufacturing cost but also the volume of the conventional input device 2 with multi luminous pattern layers is increased.

### SUMMARY OF THE INVENTION

The present invention is directed to a display device and an input device with multi luminous pattern layers capable of being manufactured with a lower cost.

The present invention is further directed to a display device and an input device with multi luminous pattern layers capable of being manufactured with a smaller volume.

In a preferred embodiment, the present invention provides a display device with multi luminous pattern layers comprising:
a first light guiding plate, having a plurality of first luminous patterns;
at least one first light emitting element, disposed at a side of the first light guiding plate and capable of generating at least one first light beam, such that the at least one first light beam is projected to the first light guiding plate, so as to display the plurality of first luminous patterns;
a second light guiding plate, disposed under the first light guiding plate, and the second light guiding plate having a plurality of second luminous patterns; and
at least one second light emitting element, disposed at the side of the first light guiding plate, adjacent to the at least one first light emitting element and capable of generating at least one second light beam, such that the at least one second light beam is projected to the second light guiding plate, so as to display the plurality of second luminous patterns.

In a preferred embodiment, the display device with multi luminous pattern layers of the present invention further comprises a circuit board disposed at the side of the first light guiding plate and capable of disposing the at least one first light emitting element and the at least one second light emitting element thereon, wherein both of the at least one first light emitting element and the at least one second light emitting element are side-view LEDs.

In a preferred embodiment, the display device with multi luminous pattern layers of the present invention further comprises:
a first light shading element, disposed on the first light guiding plate and capable of blocking the at least one second light beam from entering into the first light guiding plate from a side wall of the first light guiding plate and a lower surface of the first light guiding plate; and
a second light shading element, disposed on the second light guiding plate and capable of blocking the at least one first light beam from entering into the second light guiding plate from a side wall of the second light guiding plate and an upper surface of the second light guiding plate.

In a preferred embodiment, the first light shading element is a plastic sheet, a foam rubber, a shading plate or a shading material formed on the side wall and a partial region of the lower surface of the first light guiding plate by a coating process, a spraying process, a printing process or a sticking process, while the second light shading element is a plastic sheet, a foam rubber, a shading plate or a shading material formed on the side wall and a partial region of the upper surface of the second light guiding plate by a coating process, a spraying process, a printing process or a sticking process.

In a preferred embodiment, the display device with multi luminous pattern layers of the present invention further comprises a protective layer disposed over the first light guiding plate and capable of protecting the first light guiding plate. The protective layer comprises a light shading region and a light transmissive region. The light shading region surrounds the light transmissive region, and the light shading region is capable of blocking the at least one first light beam or the at least one second light beam from passing through the protective layer. The light transmissive region is capable of displaying the plurality of first luminous patterns or the plurality of second luminous patterns due to the at least one first light beam or the at least one second light beam, and the light transmissive region has a predetermined light shading rate. Herein, the plurality of first luminous patterns or the plurality of second luminous patterns are not displayed by the at least one first light emitting element or the at least one second light emitting element due to the predetermined light shading rate when the at least one first light emitting element or the at least one second light emitting element is not activated and the at least one first light beam or the at least one second light beam is not generated.

In a preferred embodiment, the extraneous light from outside of the input device is shaded by the light transmissive region with the predetermined light shading rate when the at least one first light beam or the at least one second light beam is not generated, such that the plurality of first luminous patterns or the plurality of second luminous patterns are not displayed. Herein, the predetermined light shading rate is ranged between 75% and 80%.

In a preferred embodiment, the present invention further provides an input device with multi luminous pattern layers comprising:
a first light guiding plate, having a plurality of first luminous patterns;
at least one first light emitting element, disposed at a side of the first light guiding plate and capable of generating at least one first light beam, such that the at least one first light beam is projected to the first light guiding plate, so as to display the plurality of first luminous patterns;
a second light guiding plate, disposed under the first light guiding plate, and the second light guiding plate having a plurality of second luminous patterns;
at least one second light emitting element, disposed at the side of the first light guiding plate, adjacent to the at least one first light emitting element and capable of generating at least one second light beam, such that the at least one second light beam is projected to the second light guiding plate, so as to display the plurality of second luminous patterns; and
an input interface, stacked with the first light guiding plate of the second light guiding plate and capable of being touched, so as to generate a touch signal.

In a preferred embodiment, the input device with multi luminous pattern layers of the present invention further comprises a circuit board disposed at the side of the first light guiding plate and capable of disposing the at least one first light emitting element and the at least one second light emitting element thereon, wherein both of the at least one first light emitting element and the at least one second light emitting element are side-view LEDs.

In a preferred embodiment, the input device with multi luminous pattern layers of the present invention further comprises:
a first light shading element, disposed on the first light guiding plate and capable of blocking the at least one second light beam from entering into the first light guiding plate from a side wall of the first light guiding plate and a lower surface of the first light guiding plate; and
a second light shading element, disposed on the second light guiding plate and capable of blocking the at least one first light beam from entering into the second light guiding plate from a side wall of the second light guiding plate and an upper surface of the second light guiding plate.

In a preferred embodiment, the first light shading element is a plastic sheet, a foam rubber, a shading plate or a shading material formed on the side wall and a partial region of the lower surface of the first light guiding plate by a coating process, a spraying process, a printing process or a sticking process, while the second light shading element is a plastic sheet, a foam rubber, a shading plate or a shading material formed on the side wall and a partial region of the upper surface of the second light guiding plate by a coating process, a spraying process, a printing process or a sticking process.

In a preferred embodiment, the input device with multi luminous pattern layers of the present invention further comprises a protective layer disposed over the first light guiding plate and capable of protecting the first light guiding plate or the input interface. The protective layer comprises a light shading region and a light transmissive region. The light shading region surrounds the light transmissive region, and the light shading region is capable of blocking the at least one first light beam or the at least one second light beam from passing through the protective layer. The light transmissive region is capable of displaying the plurality of first luminous patterns or the plurality of second luminous patterns due to the at least one first light beam or the at least one second light beam, and the light transmissive region has a predetermined light shading rate. Herein, the plurality of first luminous patterns or the plurality of second luminous patterns are not displayed by the at least one first light emitting element or the at least one second light emitting element due to the predetermined light shading rate when the at least one first light emitting element or the at least one second light emitting element is not activated and the at least one first light beam or the at least one second light beam is not generated.

In a preferred embodiment, the extraneous light from outside of the input device is shaded by the light transmissive region with the predetermined light shading rate when the at least one first light beam or the at least one second light beam is not generated, such that the plurality of first luminous patterns or the plurality of second luminous patterns are not displayed. Herein, the predetermined light shading rate is ranged between 75% and 80%.

In a preferred embodiment, the input interface is disposed under the first light guiding plate, and the input interface is an opaque printed circuit board (PCB) capacitive touch sensor.

In a preferred embodiment, the input interface is disposed over the first light guiding plate, and the input interface is a light transmissive surface capacitive touch sensor, a light transmissive inner capacitive touch sensor or a light transmissive projected capacitive touch sensor.

### BRIEF DESCRIPTION OF THE DRAWINGS

FIG. 1 illustrates a structural schematic side view of a conventional luminous input device.

FIG. 2 illustrates a structural schematic side view of a conventional input device with multi luminous pattern layers.

FIG. 3 illustrates a structural schematic side view of an input device with multi luminous pattern layers according to a first preferred embodiment of the present invention.

FIG. 4 illustrates a partial structural schematic top view of an input device with multi luminous pattern layers according to a first preferred embodiment of the present invention.

FIG. 5 illustrates a structural schematic explosion view of a first light guiding plate and a second light guiding plate of an input device with multi luminous pattern layers according to a first preferred embodiment of the present invention.

FIG. 6 illustrates a structural schematic view from another angle of view of a first light emitting element of an input device with multi luminous pattern layers disposed on a circuit board according to a first preferred embodiment of the present invention.

FIG. 7 illustrates a structural schematic top view of an input device with multi luminous pattern layers in a first operation mode according to a first preferred embodiment of the present invention.

FIG. 8 illustrates a structural schematic top view of an input device with multi luminous pattern layers in a second operation mode according to a first preferred embodiment of the present invention.

FIG. 9 illustrates a structural schematic side view of a display device with multi luminous pattern layers according to a second preferred embodiment of the present invention.

FIG. 10 illustrates a structural schematic side view of an input device with multi luminous pattern layers according to a third preferred embodiment of the present invention.

FIG. 11 illustrates a partial structural schematic top view of an input device with multi luminous pattern layers according to a third preferred embodiment of the present invention.

FIG. 12 illustrates a structural schematic explosion view of a first light guiding plate and a second light guiding plate of an input device with multi luminous pattern layers according to a third preferred embodiment of the present invention.

FIG. 13 illustrates a structural schematic side view of a display device with multi luminous pattern layers according to a fourth preferred embodiment of the present invention.

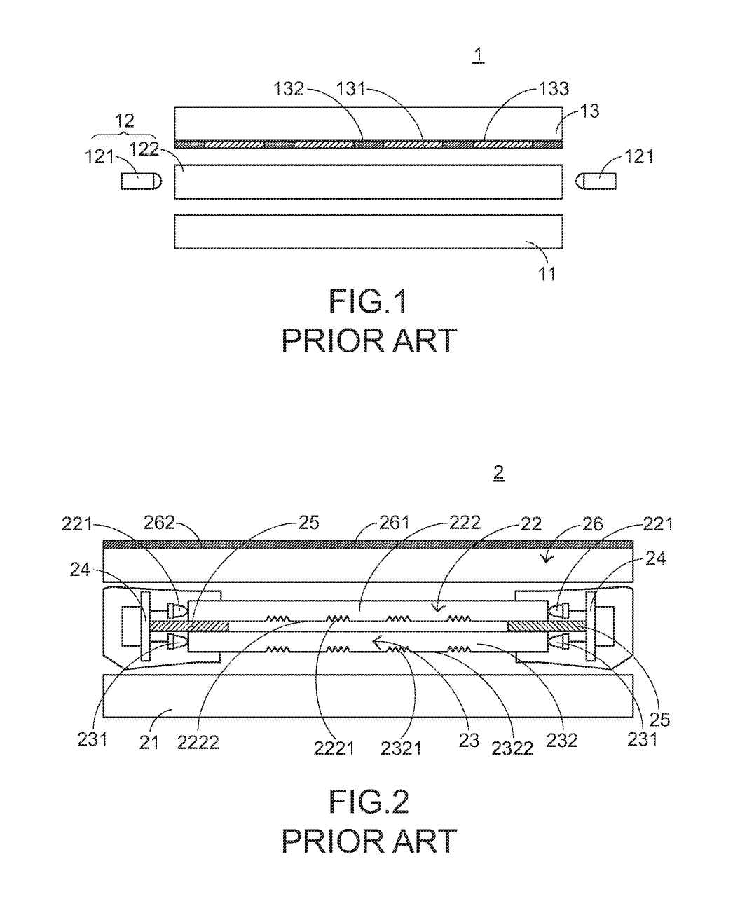

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

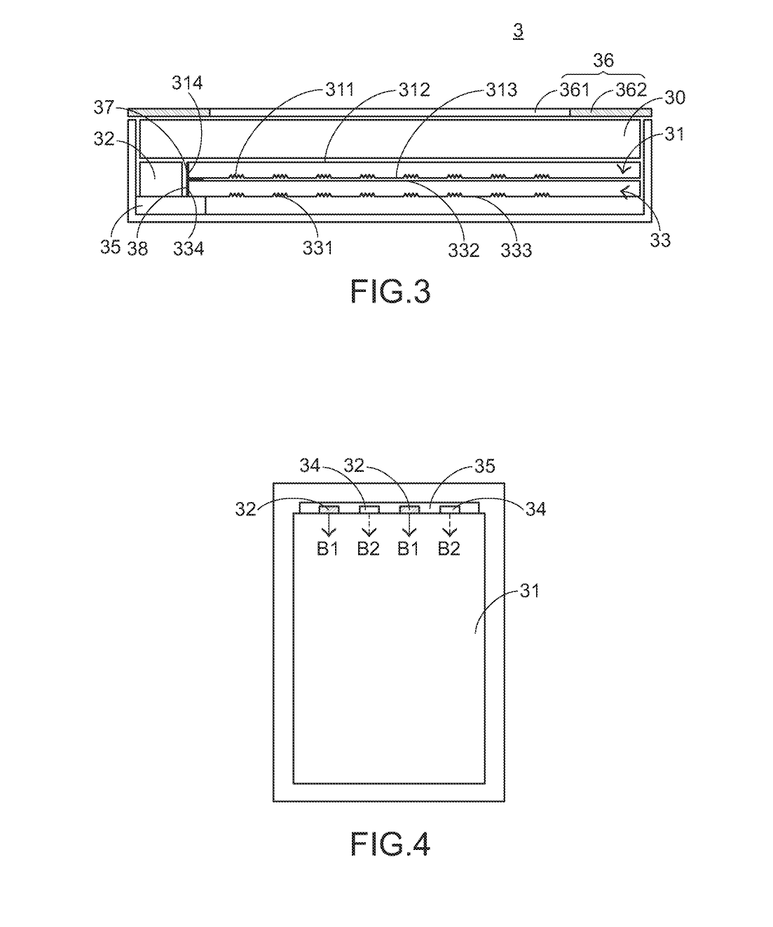

In view of the defects of the conventional arts, the present invention provides an input device with multi luminous pattern layers. FIG. 3 illustrates a structural schematic side view of an input device with multi luminous pattern layers according to a first preferred embodiment of the present invention, while FIG. 4 illustrates a partial structural schematic top view of an input device with multi luminous pattern layers according to a first preferred embodiment of the present invention. Referring to FIG. 3 and FIG. 4 together, the input device 3 with multi luminous pattern layers comprises an input interface 30, a first light guiding plate 31, a plurality of first light emitting elements 32, a second light guiding plate 33, a plurality of second light emitting elements 34, a circuit board 35, a protective layer 36, a first light shading element 37 and a second light shading element 38. Herein, a bottom-up arranging sequence thereof is the circuit board 35, the second light guiding plate 33, the second light shading element 38, the first light shading element 37, the first light guiding plate 31, the input interface 30 and the protective layer 36. Further, the plurality of first light emitting elements 32 are arranged at a side of the first light guiding plate 31, while the plurality of second light emitting elements 34 the second light guiding plate 33.

As illustrated in FIG. 3, the first light guiding plate 31 has a plurality of first luminous patterns 311, wherein the first luminous patterns 311 are disposed on an upper surface 312 or a lower surface 313 of the first light guiding plate 31. In addition, the plurality of first light emitting elements 32 are disposed to the side of the first light guiding plate 31 and capable of generating at least a first light beam B1, such that the at least one first light beam B1 is projected to the first light guiding plate 31, so as to display the plurality of first luminous patterns 311. In contrast, the second light guiding plate 33 is disposed under the first light guiding plate 31, and the second light guiding plate 33 has a plurality of second luminous patterns 331, wherein the second luminous patterns 331 are disposed on an upper surface 332 or a lower surface 333 of the second light guiding plate 33. In addition, the plurality of second light emitting elements 34 are disposed to the side of the second light guiding plate 33 and capable of generating at least a second light beam B2, such that the at least one second light beam B2 is projected to the second light guiding plate 33, so as to display the plurality of second luminous patterns 331. In another word, the first luminous patterns 311 on the first light guiding plate 31 is displayed as the first light emitting elements 32 generate the first light beam B1, while the second luminous patterns 331 on the second light guiding plate 33 is displayed as the second light emitting elements 34 generate the second light beam B2. In the present preferred embodiment, the plurality of first luminous patterns 311 are disposed on the lower surface 313 of the first light guiding plate 31, while the plurality of second luminous patterns 331 are disposed on the lower surface 333 of the second light guiding plate 33.

In the first light guiding plate 31 and the second light guiding plate 33, each one of the first luminous patterns 311 or each one of the second luminous patterns 331 is formed from a plurality of micro structures of light guide arranged densely, and each one of the plurality of micro structures of light guide may be a plurality of micro structures (such as micro lenses, v-cuts, etc.) arranged densely or a plurality of mesh points arranged densely. The plurality of micro structures of light guide for forming the first luminous patterns 311 and the second luminous patterns 331 are used for varying incident angles of a partial light inside the first light guiding plate 31 or the second light guiding plate 33. As a result, the partial light may be refracted to pass through the first light guiding plate 31 or the second light guiding plate 33 due to the total reflection paths of the partial light are changed, such that the partial light reveals from the top side of the micro structures of light guide, so as to present the first luminous patterns 311 or the second luminous patterns 331.

In addition, the input interface 30 is stacked with the first light guiding plate 31, arranged over the first light guiding plate 31, and capable of being activated by a user with his finger or a stylus, so as to correspondingly generate at least one touch signal. In the present preferred embodiment, the input interface 30 can use a light transmissive surface resistive touch sensor, in other preferred embodiments, however, the input interface can use a light transmissive inner capacitive touch sensor or a light transmissive projected capacitive touch sensor as well.

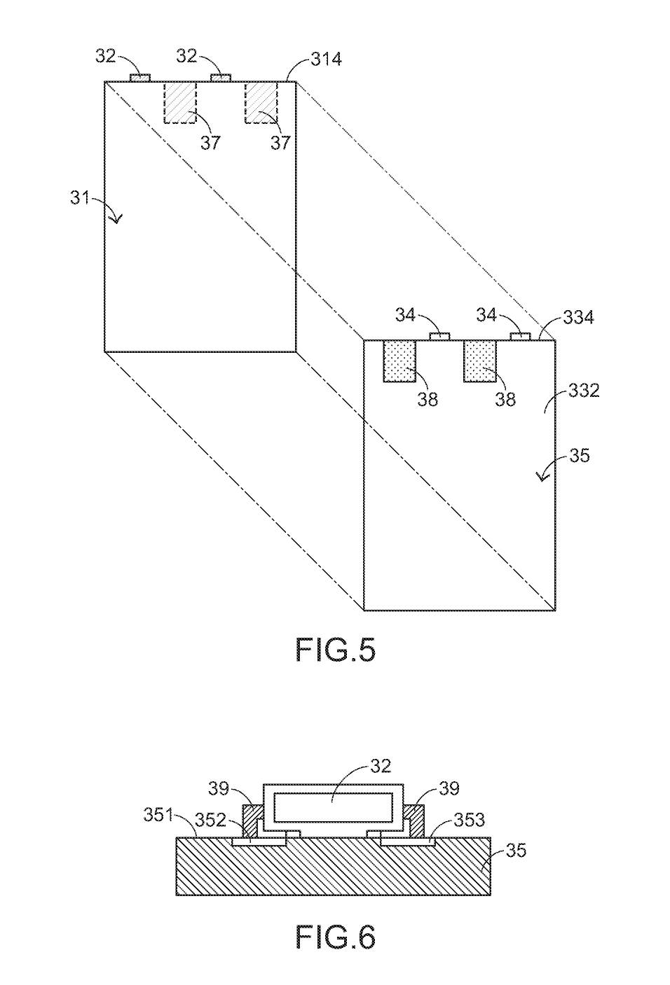

Next, the first light shading element 37 and the second light shading element 38 are illustrated hereinafter. FIG. 5 illustrates a structural schematic explosion view of a first light guiding plate and a second light guiding plate of an input device with multi luminous pattern layers according to a first preferred embodiment of the present invention. Referring to FIG. 3 and FIG. 5 together, the first light shading element 37 is disposed on a side wall 314 of the first light guiding plate 31 and the region in the lower surface 313 of the first light guiding plate 31 close to the first light emitting elements 32, and capable of blocking the second light beam B2 from entering into the second light guiding plate 33. In contrast, the second light shading element 38 is disposed on a side wall 334 of the second light guiding plate 33 and the region in the upper surface 332 of the second light guiding plate 33 close to the second light emitting elements 34, and capable of blocking the first light beam B1 from entering into the first light guiding plate 31. In the present preferred embodiment, the first light shading element 37 is a shading material formed on the side wall 314 and the lower surface 313 of the first light guiding plate 31 by a coating process, a spraying process, a printing process or a sticking process, and the second light shading element 38 is a shading material formed on the side wall 334 and the upper surface 332 of the second light guiding plate 31 by a coating process, a spraying process, a printing process or a sticking process as well.

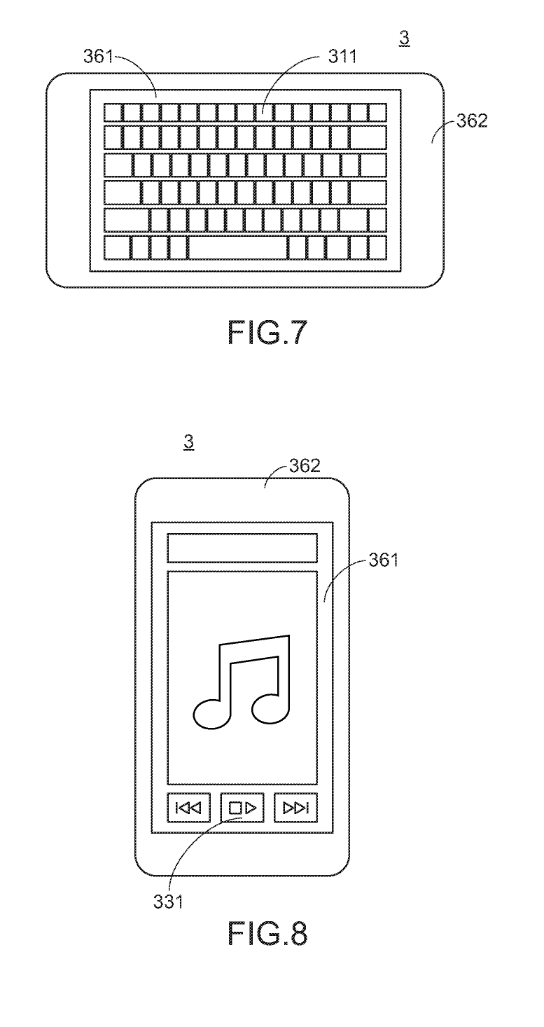

As illustrated in FIG. 3 and FIG. 4, the circuit board 35 is disposed at the sides of the first light guiding plate 31 and the second light guiding plate 33, and the circuit board 35 is parallel to the first light guiding plate 322 and the second light guiding plate 332. In addition, the plurality of first light emitting elements 32 and the second light emitting elements 34 are capable of being disposed on the circuit board 35. Further, as illustrated in FIG. 3, the protective layer 36 is disposed over the input interface 30, and the protective layer 36 is capable of protecting the input interface 30. Moreover, the protective layer 36 comprises a light transmissive region 361 and a light shading region 362, wherein the light shading region 362 surrounds the light transmissive region 361 (as illustrated in FIG. 7), and the light shading region 362 is capable of shading the first light beam B1, the second light beam B2 or the external light. Besides, the light transmissive region 361 is capable of displaying the first luminous patterns 311 or the second luminous patterns 331 due to the first light beam B1 or the second light beam B2, and the light transmissive region 361 has a predetermined light shading rate, wherein the predetermined light shading rate is ranged between 75% and 80%.

FIG. 6 illustrates a structural schematic view from another angle of view of a first light emitting element of an input device with multi luminous pattern layers disposed on a circuit board according to a first preferred embodiment of the present invention. After that, referring to FIG. 6, the circuit board 35 has a first metal contact 352 and a second metal contact 353, both of the first metal contact 352 and the second metal contact 353 are disposed on an upper surface 351 of the circuit board 35. Herein, the first light emitting element 32 is mounted to the first metal contact 352 arranged on the upper surface 351 of the circuit board 35 by a welding process with a welding element 39, and the welding element 39 in the present preferred embodiment is Tin metal. Similarly, the second light emitting element 34 is disposed on the upper surface 351 of the circuit board 35 and next to the first light emitting element 32 as well. Also, the second light emitting element 34 is mounted to the second metal contact 353 arranged on the upper surface 351 of the circuit board 35 by a welding process with the welding element 39. According to FIG. 5, it is understood that all of the plurality of first light emitting element 32 and the plurality of second light emitting element 34 are side-view LEDs.

Referring to FIG. 3 again, in the present preferred embodiment, each one of the first light emitting elements 32 and the second light emitting elements 34 is practiced by using the LED with a larger volume and a thickness thereof is about 0.8 mm, however, a thickness of each one of the first light guiding plate 31 and the second light guiding plate 33 is about 0.4 mm. As a result, all of the first light beams B1 generated by the first light emitting elements 32 and the second light beams B2 generated by the second light emitting elements 34 are projected into both of the first light guiding plate 31 and the second light guiding plate 33. Accordingly, the arrangement of the first light shading element 37 is capable of blocking the second light beams B2, so as to clearly display the first luminous patterns 311 with the first light beams B1 without being affected by the second light beams B2. On the contrary, the arrangement of the second light shading element 38 is capable of blocking the first light beams B1, so as to clearly display the second luminous patterns 331 with the second light beams B2 without being affected by the first light beams B1.

In the input device 3 with multi luminous pattern layers, when all of the first light emitting elements 32 and the second light emitting elements 34 are inactivated and thus all of the first light beams B1 and the second light beams B2 are not generated, neither the plurality of first luminous patterns 311 nor the plurality of second luminous patterns 331 are displayed due to the predetermined light shading rate of the light transmissive region 361. It is resulted from that only the faint external light coming from the ambient environment is able to be transmitted into the light transmissive region 361 of the protective layer 36 when all of the first light emitting elements 32 do not generate the first light beams B1 and all of the second light emitting elements 34 do not generate the second light beams B2, and the predetermined light shading rate of the light transmissive region 361 is ranged between 75% and 80%. As a result, the faint light transmitted into the light transmissive region 361 is absorbed by the light transmissive region 361 about 75% to 80%, and the faint light remaining about 20% to 25% passes through the input interface 30 and then is incident to the first light guiding plate 31. When the faint light remaining about 20% to 25% arrives the micro structures of light guide on the lower surface 313 of the first light guiding plate 31, about half of the remaining faint light is refracted and then transmitted towards a lower side of the first light guiding plate 31 due to the remaining faint light transmitted in various directions is incident to the micro structures of light guide with different incident angles. Hence, there remains only about 10% of the faint light reflected towards the input interface 30. Next, the faint light is absorbed by the light transmissive region 361 again during the faint light is reflected, such that there remains only about 2% of the faint light reveals from the light transmissive region 361. Accordingly, the first luminous patterns 311 and the second luminous patterns 331 would not be displayed, i.e. the user would not see the first luminous patterns 311 and the second luminous patterns 331.

FIG. 7 illustrates a structural schematic top view of an input device with multi luminous pattern layers in a first operation mode according to a first preferred embodiment of the present invention, and FIG. 8 illustrates a structural schematic top view of an input device with multi luminous pattern layers in a second operation mode according to a first preferred embodiment of the present invention. Referring to FIG. 3 and FIG. 7 together, when the first light emitting elements 32 are activated and thus the first light beams B1 are generated, a significant amount of the first light beams B1 are transmitted into the first light guiding plate 31 from the side wall 314 thereof. Further, when the first light beams B1 pass through the first luminous patterns 311 formed from the micro structures of light guide during being transmitted into the first light guiding plate 31, the first light beams B1 are transmitted towards an upper side of the first light guiding plate 31 due to the total reflection paths thereof are changed by the micro structures of light guide. In such a case, the first light beams B1 are absorbed by the light transmissive region 361 about 75% to 80% during the first light beams B1 pass through the input interface 30 and are transmitted into the light transmissive region 361 of the protective layer 36. As a result, there are still about 20% to 25% of the first light beams B1 able to pass through the light transmissive region 361 and then to display the lighted first luminous patterns 311, and thus the user can see the lighted first luminous patterns 311 as illustrated in FIG. 7.

The operation case for activating the second light emitting elements 34 of the input device 3 with multi luminous pattern layers is similar to the above-mentioned operation case for activating the first light emitting elements 32 and thus is omitted herein. In a word, the user can see the lighted second luminous patterns 331 as illustrated in FIG. 8 when the second light emitting elements 34 of the input device 3 with multi luminous pattern layers are activated. According to FIG. 7 and FIG. 8, it can be understood that the plurality of first luminous patterns 311 form as a keyboard interface capable of being used to input letters of the alphabet, symbols and numbers, and the plurality of second luminous patterns 331 form as a music player interface capable of being used to control the music playback.

There are three points need to be specified. First, since all of the plurality of first emitting elements 32 and the plurality of second emitting elements 34 are disposed on the same circuit board 35, it is able to dispose only one circuit board inside the input device 3 with multi luminous pattern layers. As a result, a width or a length of the input device 3 with multi luminous pattern layers is decreased, and the manufacturing cost can be reduced as well. Taking into account a size of a palm of the user, a shape of the input device 3 is designed as an elongated shape (a rectangle with a smaller width and a larger length) to be held by the user more easily. In addition, in order to minimize the width to be held by the user more easily, the circuit board 35 of the input device 3 with multi luminous pattern layers is disposed on the shorter side.

Second, the first light emitting elements 32 and the second light emitting elements 34 are disposed on the circuit board 35 in an alternate arrangement, such that the first light beams B1 generated by the first light emitting elements 32 and the second light beams B2 generated by the second light emitting elements 34 are able to be respectively projected on the first luminous patterns 311 and the second luminous patterns 331 uniformly. Third, each one of the first light emitting elements 32 and the second light emitting elements 34 is practiced by using the LED with a larger volume and a thickness thereof is about 0.8 mm. Since the LED having a larger volume can be manufactured with a lower cost and generate a light beam with larger luminous efficiency, such that not only the manufacturing cost of the input device 3 can be reduced, but also the luminous efficiency of the light emitting element can be enhanced.

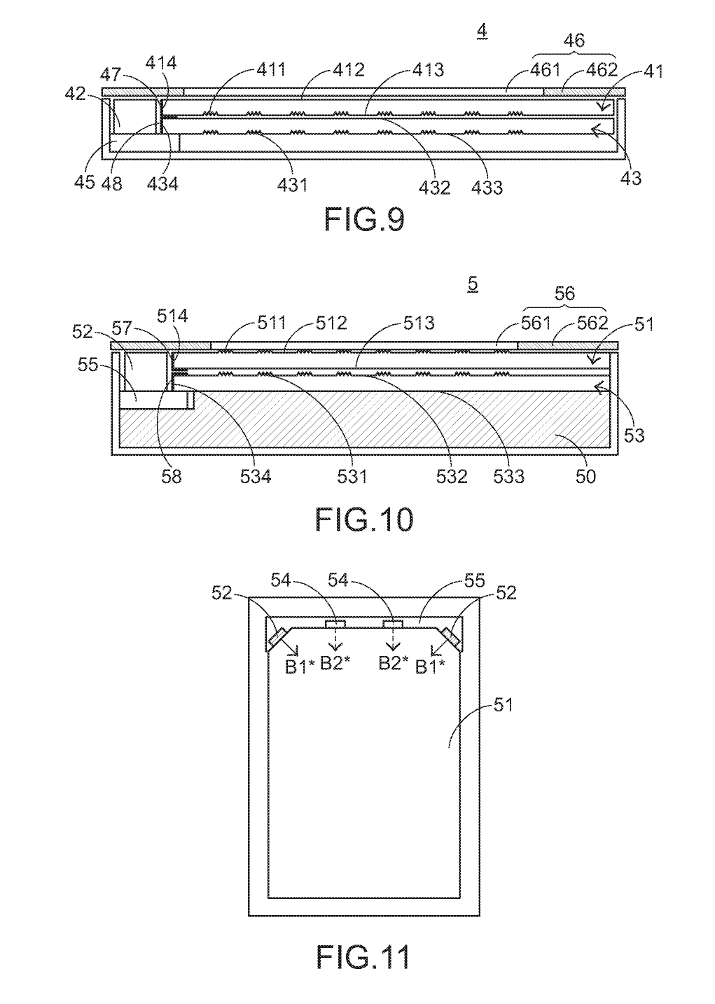

In addition, the present invention further provides a second preferred embodiment. FIG. 9 illustrates a structural schematic side view of a display device with multi luminous pattern layers according to a second preferred embodiment of the present invention. Referring to FIG. 9, the input device 4 with multi luminous pattern layers comprises a first light guiding plate 41, a plurality of first light emitting elements 42, a second light guiding plate 43, a plurality of second light emitting elements 44, a circuit board 45, a protective layer 46, a first light shading element 47 and a second light shading element 48. Herein, a bottom-up arranging sequence thereof is the circuit board 45, the second light guiding plate 43, the second light shading element 48, the first light shading element 47, the first light guiding plate 41 and the protective layer 46. The structure of the input device 4 with multi luminous pattern layers of the present preferred embodiment and the functions of each of the components thereof are substantially the same as those of the input device 3 with multi luminous pattern layers of the first preferred embodiment. The only difference there between is that the input device 4 with multi luminous pattern layers is not disposed with the input interface, and the other similarities are omitted herein.

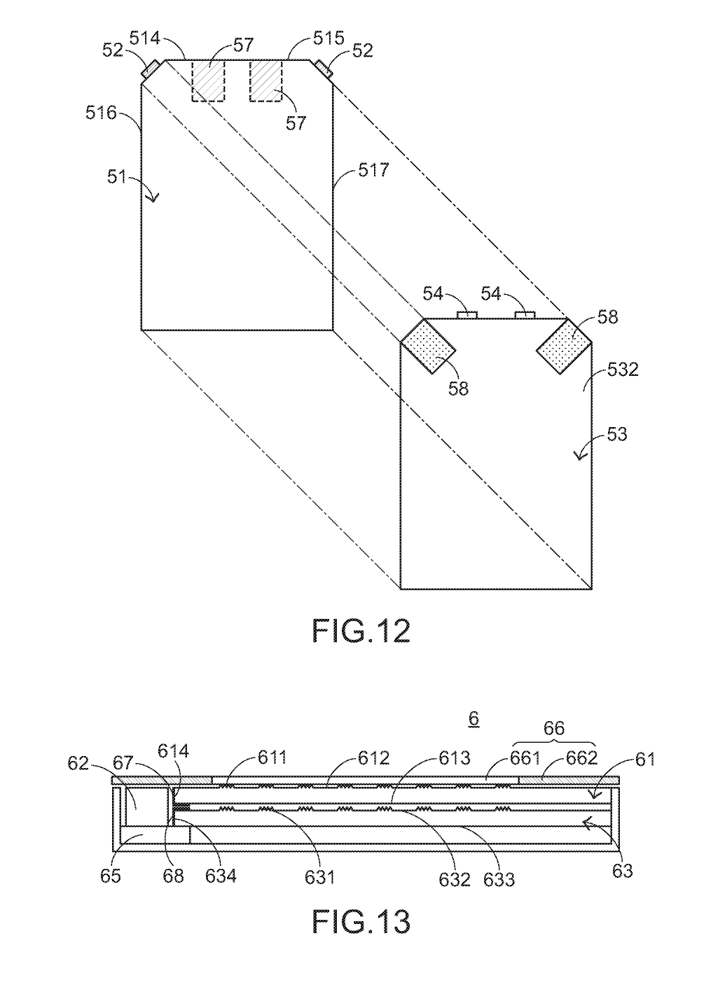

Moreover, the present invention provides a third preferred embodiment as well. FIG. 10 illustrates a structural schematic side view of an input device with multi luminous pattern layers according to a third preferred embodiment of the present invention, and FIG. 11 illustrates a partial structural schematic top view of an input device with multi luminous pattern layers according to a third preferred embodiment of the present invention, while FIG. 12 illustrates a structural schematic explosion view of a first light guiding plate and a second light guiding plate of an input device with multi luminous pattern layers according to a third preferred embodiment of the present invention. Referring to FIG. 10 and FIG. 11 together, the input device 5 with multi luminous pattern layers comprises an input interface 50, a first light guiding plate 51, a plurality of first light emitting elements 52, a second light guiding plate 53, a plurality of second light emitting elements 54, a circuit board 55, a protective layer 56, a first light shading element 57 and a second light shading element 58. Herein, a bottom-up arranging sequence thereof is the input interface 50, the circuit board 55, the second light guiding plate 53, the second light shading element 58, the first light shading element 57, the first light guiding plate 51 and the protective layer 56. In addition, the plurality of first light emitting elements 52 and the plurality of second light emitting elements 54 are arranged at a side of the first light guiding plate 51 and a side of the second light guiding plate 53.

The structure of the input device 5 with multi luminous pattern layers of the present preferred embodiment and the functions of each of the components thereof are substantially the same as those of the input device 3 with multi luminous pattern layers of the first preferred embodiment, and thus are omitted herein. There are four differences there between. First, the input interface 50 is disposed under the first light guiding plate 51 as illustrated in FIG. 10. In the present preferred embodiment, the input interface 50 is an PCB capacitive touch sensor. Second, the plurality of first luminous patterns 511 are disposed on an upper surface 512 of the first light guiding plate 51, while the plurality of second luminous patterns 531 are disposed on an upper surface 532 of the second light guiding plate 53 as illustrate in FIG. 10.

Third, the plurality of first light emitting elements 52 and the plurality of second light emitting elements 54 are all disposed on the same circuit board 55. In addition, one of the plurality of first light emitting elements 52 is arranged at a junction between a first short edge 515 and a first long edge 516 of the first light guiding plate 51, and the other one of the plurality of first light emitting elements 52 is arranged at a junction between the first short edge 515 and a second long edge 517 of the first light guiding plate 51. In contrast, the plurality of second light emitting elements 54 are arranged between the plurality of first light emitting elements 52 as illustrated in FIG. 11. In another word, the first light emitting elements 52 and the second light emitting elements 54 are disposed on the circuit board 55 in an arrangement different from the alternate arrangement of the first preferred embodiment. This arrangement is capable of uniformly projecting the first light beam B1* generated by the first light emitting elements 52 and the second light beam B2* generated by the second light emitting elements 54 on the first luminous patterns 511 and the second luminous patterns 531 as well.

Fourth, the first light shading element 57 is disposed on a side wall 514 of the first light guiding plate 51 and a region of a lower surface 513 of the first light guiding plate 51 adjacent to the first light emitting elements 52, and capable of blocking the second light beam B2* from entering into the first light guiding plate 51. In contrast, the second light shading element 58 is disposed on a side wall 534 of the second light guiding plate 53 and a region of a lower surface 532 of the second light guiding plate 53 adjacent to the second light emitting elements 54, and capable of blocking the first light beam B1* from entering into the second light guiding plate 53 as illustrated in FIG. 12.

Furthermore, the present invention further provides a fourth preferred embodiment, which illustrates a display device with multi luminous pattern layers. FIG. 13 illustrates a structural schematic side view of a display device with multi luminous pattern layers according to a fourth preferred embodiment of the present invention. Referring to FIG. 13, the display device 6 with multi luminous pattern layers comprises a first light guiding plate 61, a plurality of first light emitting elements 62, a second light guiding plate 63, a plurality of second light emitting elements 64, a circuit board 65, a protective layer 66, a first light shading element 67 and a second light shading element 68. Also, a bottom-up arranging sequence thereof is the circuit board 65, the second light guiding plate 63, the second light shading element 68, the first light shading element 67, the first light guiding plate 61 and the protective layer 66. The functions and the connection relationships of each of the components of the display device 6 with multi luminous pattern layers of the present preferred embodiment are substantially the same as those of the input device 5 with multi luminous pattern layers of the third preferred embodiment. The difference there between is only that the display device 6 with multi luminous pattern layers is not disposed with the input interface, and the other similarities are omitted herein.

According to the above mentioned preferred embodiments, it is understood that the plurality of first light emitting elements and the plurality of second light emitting elements are disposed on the same circuit board, such that it is able to dispose only one circuit board inside the display device and the input device. As a result, not only the volumes of the display device and the input device are able to be reduced, but also the other costs of the circuit board are able to be saved. Besides, the plurality of first light emitting elements and the plurality of second light emitting elements are practiced by using the LEDs with larger volumes, which are capable of providing larger light quantities due to having higher output efficiency. In addition, the LED with a larger volume has a lower manufacturing cost, so as to further reduce the total cost of the display device and the input device of the present invention.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A display device with multi luminous pattern layers, comprising:
a first light guiding plate, having a plurality of first luminous patterns;
at least one first light emitting element, disposed at a side of the first light guiding plate and capable of generating at least one first light beam, such that the at least one first light beam is projected to the first light guiding plate, so as to display the plurality of first luminous patterns;
a second light guiding plate, disposed under the first light guiding plate, and the second light guiding plate having a plurality of second luminous patterns; and
at least one second light emitting element, disposed at the side of the first light guiding plate, adjacent to the at least one first light emitting element and capable of generating at least one second light beam, such that the at least one second light beam is projected to the second light guiding plate, so as to display the plurality of second luminous patterns.

2. The display device with multi luminous pattern layers as claimed in claim 1, further comprising a circuit board disposed at the side of the first light guiding plate and capable of disposing the at least one first light emitting element and the at least one second light emitting element thereon, wherein both of the at least one first light emitting element and the at least one second light emitting element are side-view LEDs.

3. The display device with multi luminous pattern layers as claimed in claim 1, further comprising:
a first light shading element, disposed on the first light guiding plate and capable of blocking the at least one second light beam from entering into the first light guiding plate from a side wall of the first light guiding plate and a lower surface of the first light guiding plate; and
a second light shading element, disposed on the second light guiding plate and capable of blocking the at least one first light beam from entering into the second light guiding plate from a side wall of the second light guiding plate and an upper surface of the second light guiding plate.

4. The display device with multi luminous pattern layers as claimed in claim 3, wherein the first light shading element is a plastic sheet, a foam rubber, a shading plate or a shading material formed on the side wall and a partial region of the lower surface of the first light guiding plate by a coating process, a spraying process, a printing process or a sticking process, while the second light shading element is a plastic sheet, a foam rubber, a shading plate or a shading material formed on the side wall and a partial region of the upper surface of the second light guiding plate by a coating process, a spraying process, a printing process or a sticking process.

5. The display device with multi luminous pattern layers as claimed in claim 1, further comprising a protective layer disposed over the first light guiding plate and capable of protecting the first light guiding plate, and the protective layer comprising a light shading region and a light transmissive region, the light shading region surrounding the light transmissive region, and the light shading region capable of blocking the at least one first light beam or the at least one second light beam from passing through the protective layer, while the light transmissive region capable of displaying the plurality of first luminous patterns or the plurality of second luminous patterns due to the at least one first light beam or the at least one second light beam, and the light transmissive region having a predetermined light shading rate, wherein the plurality of first luminous patterns or the plurality of second luminous patterns are not displayed by the at least one first light emitting element or the at least one second light emitting element due to the predetermined light shading rate when the at least one first light emitting element or the at least one second light emitting element is not activated and the at least one first light beam or the at least one second light beam is not generated.

6. The display device with multi luminous pattern layers as claimed in claim 5, wherein the extraneous light from outside of the input device is shaded by the light transmissive region with the predetermined light shading rate when the at least one first light beam or the at least one second light beam is not generated, such that the plurality of first luminous patterns or the plurality of second luminous patterns are not displayed, and the predetermined light shading rate is ranged between 75% and 80%.

7. An input device with multi luminous pattern layers, comprising:
a first light guiding plate, having a plurality of first luminous patterns;
at least one first light emitting element, disposed at a side of the first light guiding plate and capable of generating at least one first light beam, such that the at least one first light beam is projected to the first light guiding plate, so as to display the plurality of first luminous patterns;
a second light guiding plate, disposed under the first light guiding plate, and the second light guiding plate having a plurality of second luminous patterns;
at least one second light emitting element, disposed at the side of the first light guiding plate, adjacent to the at least one first light emitting element and capable of generating at least one second light beam, such that the at least one second light beam is projected to the second light guiding plate, so as to display the plurality of second luminous patterns; and
an input interface, stacked with the first light guiding plate of the second light guiding plate and capable of being touched, so as to generate a touch signal.

8. The input device with multi luminous pattern layers as claimed in claim 7, further comprising a circuit board disposed at the side of the first light guiding plate and capable of disposing the at least one first light emitting element and the at least one second light emitting element thereon, wherein both of the at least one first light emitting element and the at least one second light emitting element are side-view LEDs.

9. The input device with multi luminous pattern layers as claimed in claim 7, further comprising:
a first light shading element, disposed on the first light guiding plate and capable of blocking the at least one second light beam from entering into the first light guiding plate from a side wall of the first light guiding plate and a lower surface of the first light guiding plate; and
a second light shading element, disposed on the second light guiding plate and capable of blocking the at least one first light beam from entering into the second light guiding plate from a side wall of the second light guiding plate and an upper surface of the second light guiding plate.

10. The input device with multi luminous pattern layers as claimed in claim 9, wherein the first light shading element is a plastic sheet, a foam rubber, a shading plate or a shading material formed on the side wall and a partial region of the lower surface of the first light guiding plate by a coating process, a spraying process, a printing process or a sticking process, while the second light shading element is a plastic sheet, a foam rubber, a shading plate or a shading material formed on the side wall and a partial region of the upper surface of the second light guiding plate by a coating process, a spraying process, a printing process or a sticking process.

11. The input device with multi luminous pattern layers as claimed in claim 7, further comprising a protective layer disposed over the first light guiding plate and capable of protecting the first light guiding plate or the input interface, and the protective layer comprising a light shading region and a light transmissive region, the light shading region surrounding the light transmissive region, and the light shading region capable of blocking the at least one first light beam or the at least one second light beam from passing through the protective layer, while the light transmissive region capable of displaying the plurality of first luminous patterns or the plurality of second luminous patterns due to the at least one first light beam or the at least one second light beam, and the light transmissive region having a predetermined light shading rate, wherein the plurality of first luminous patterns or the plurality of second luminous patterns are not displayed by the at least one first light emitting element or the at least one second light emitting element due to the predetermined light shading rate when the at least one first light emitting element or the at least one second light emitting element is not activated and the at least one first light beam or the at least one second light beam is not generated.

12. The input device with multi luminous pattern layers as claimed in claim 11, wherein the extraneous light from outside of the input device is shaded by the light transmissive region with the predetermined light shading rate when the at least one first light beam or the at least one second light beam is not generated, such that the plurality of first luminous patterns or the plurality of second luminous patterns are not displayed, and the predetermined light shading rate is ranged between 75% and 80%.

13. The input device with multi luminous pattern layers as claimed in claim 7, wherein the input interface is disposed under the first light guiding plate, and the input interface is an opaque printed circuit board capacitive touch sensor.

14. The input device with multi luminous pattern layers as claimed in claim 7, wherein the input interface is disposed over the first light guiding plate, and the input interface is a light transmissive surface capacitive touch sensor, a light transmissive inner capacitive touch sensor or a light transmissive projected capacitive touch sensor.
